(19) United States
(12) Patent Application Publication
(10) Pub. No.: US 2021/0206085 A1
(43) Pub. Date: Jul. 8, 2021

(54) BUILD MATERIAL DISPENSER REFILL CONTROL FOR ADDITIVE MANUFACTURING

(71) Applicant: HEWLETT-PACKARD DEVELOPMENT COMPANY, L.P., Spring, TX (US)

(72) Inventors: Mike RODE, Vancouver, WA (US); John GEILE, Vancouver, WA (US); Haseeb YUSEF, Vancouver, WA (US); Tristan DUDIK, Vancouver, WA (US); Pierre J. KAISER, Vancouver, WA (US); Sam SCOFIELD, Vancouver, WA (US); Brent EWALD, Vancouver, WA (US)

(73) Assignee: HEWLETT-PACKARD DEVELOPMENT COMPANY, L.P., Houston, TX (US)

(21) Appl. No.: 16/075,481

(22) PCT Filed: Jun. 28, 2017
(86) PCT No.: PCT/US2017/039758

§ 371 Date: Aug. 3, 2018

(51) Int. Cl. B29C 64/329; B29C 64/393; B33Y 30/00; B33Y 50/02; B29C 64/255; B33Y 40/00

(52) U.S. Cl. CPC B29C 64/329; B29C 64/393; B33Y 30/00; B29C 64/153; B29C 64/255; B33Y 40/00; B33Y 50/02

(57) ABSTRACT

In one example, a refill control system to control the flow of powdered build material to a dispenser to periodically refill the dispenser with powdered build material. In one example, the refill control system includes a container to hold powered build material and a valve operable between a closed position to block a flow of powdered build material from the container to the dispenser and an open position to not block the flow of powdered build material from the container to the dispenser. The container is movable from a first position to a second position to connect the container to the dispenser and from the second position to the first position to disconnect the container from the dispenser.

### BACKGROUND

Additive manufacturing machines produce 3D (three-dimensional) objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices each defining that part of a layer or layers of build material to be formed into the object.

### DRAWINGS

FIG. 1 is a block diagram illustrating one example of a build material powder delivery system for additive manufacturing.

FIGS. 2 and 3 are perspective views illustrating one example of a refill control system for a powder dispenser, such as might be used in the build material delivery system shown in FIG. 1.

FIGS. 4 and 5 are lengthwise section views of the example powder refill control system shown in FIGS. 2 and 3.

FIGS. 6-11 present a sequence of widthwise section views illustrating an example dispenser refill operation using the refill control system shown in FIGS. 2-5,

FIG. 12 is a lengthwise section view taken along the line 12-12 in the example refill control system shown in FIG. 8.

The same part numbers designate the same or similar parts throughout the figures. The figures are not necessarily to scale.

### DESCRIPTION

In some additive manufacturing processes, heat is used to fuse together the particles in very thin layers of a powdered build material to form a solid object. Heat to fuse the build material may be generated, for example, by applying a liquid fusing agent to a layer of powdered build material in a pattern based on the object slice and then exposing the patterned area to light or other fusing energy. Energy absorbing components in the fusing agent absorb energy to help sinter, melt or otherwise fuse the build material. The process is repeated for hundreds or thousands of layers to complete the object.

One of the challenges of additive manufacturing with powdered build materials is transporting and dispensing build material powders to the manufacturing area. As additive manufacturing techniques become more sophisticated, the desirability of using multiple and different powders to make a single object or even a single layer of an object is increasing. It has been discovered that a pneumatic powder transport system and a less bulky, more nimble dispenser may be used to quickly and precisely dispense small “doses” of powder to make one layer of an object, thus improving the ability to customize the build material layer by layer as the object is manufactured.

A new system has been developed to help more effectively transport and dispense build material powders to the manufacturing area in an additive manufacturing machine. In one example, a refill control system is used to control the flow of powdered build material from a pneumatic transport system to a dispenser to periodically refill the dispenser with powder. The refill control system includes a movable container to hold powder for refilling the dispenser and a valve to control the flow of powder from the refill container to the dispenser. When the dispenser moves into a refill position below the container, the container moves down to connect to the dispenser. A contact surface on the refill container surrounding the outlet contacts a mating surface on the dispenser to enclose the powder flow path during refilling. When the dispenser is full, the frictional flow properties of the powder chokes off the flow in the closed flow path, automatically stopping the flow of powder. The valve then closes and the refill container moves up to disengage from the dispenser. The enclosed flow path enables this passive “choked flow” shut-off mechanism while maintaining a consistent powder level in the dispenser at each refill, regardless of how much powder is in the dispenser when it moves into the refill position. The enclosed flow path also helps minimize the release of airborne powder into the manufacturing area during a refill operation.

In one example, the refill control system also include an occupier that protrudes into the dispenser during refilling. The occupier occupies space in the interior volume of the dispenser, displacing powder that would otherwise refill into that space. As the refill container moves up to disengage from the dispenser, the occupier is withdrawn from the dispenser and build material powder fills the void left by the occupier to achieve the desired fill level in the dispenser. The size of the occupier may be selected to achieve the desired fill level. For example, a larger occupier may be used for a lower fill level and a smaller occupier used for a higher fill level. The occupier may also be used to make space in the dispenser for any build material that remains between the valve the dispenser when the flow stops, to help reduce waste and to help reduce the risk of introducing airborne powder into the work area.

This and other examples described below and shown in the figures illustrate but do not limit the scope of the patent, which is defined in the Claims following this Description.

“Powder” as used in this document means matter in a finely divided state including, for example, particulate matter and fibrous matter.

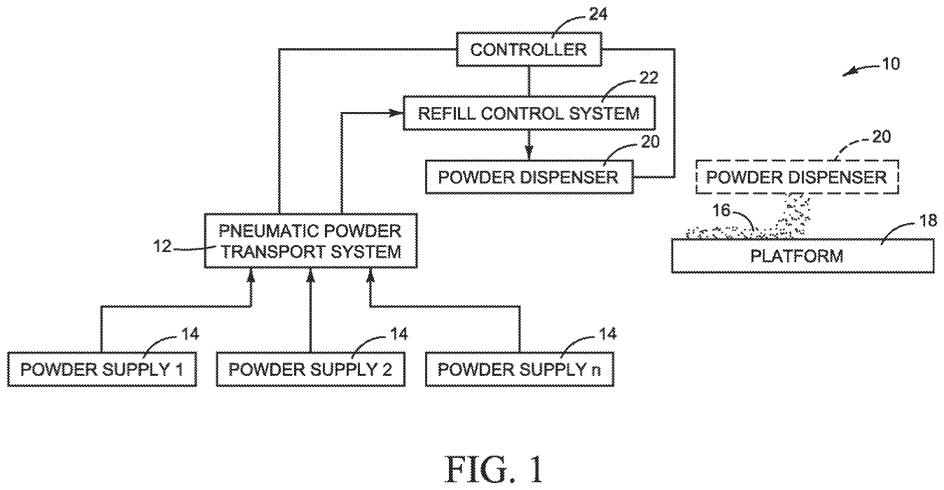

FIG. 1 is a block diagram illustrating one example of a build material delivery system 10 for additive manufacturing. Referring to FIG. 1, delivery system 10 includes a pneumatic powder transport system 12 operatively coupled to multiple powdered build material supplies 14. Each powder supply 14 may supply the same or a different build material powder including, for example, powders with different colors, powders with different mechanical or electrical characteristics, and new and recycled powder. Build material powder 16 is dispensed on to a supply deck or build platform 18 with a dispenser 20, for layering in the additive manufacturing of an object. Dispenser 20 is periodically refilled with powder 16 from one or more supplies 14 through transport system 12 and a refill control system 22 operating at the direction of a controller 24. Refill control system 22 controls the flow of build material from powder transport 12 to dispenser 20. Dispenser 20 is shown in solid lines representing a refill position under refill control system 22 and in dashed lines representing a dispensing position over platform 18. Controller 24 in FIG. 1 represents the programming, processing and associated memory resources, and the other electronic circuitry and components to control the operative elements of delivery system 10.

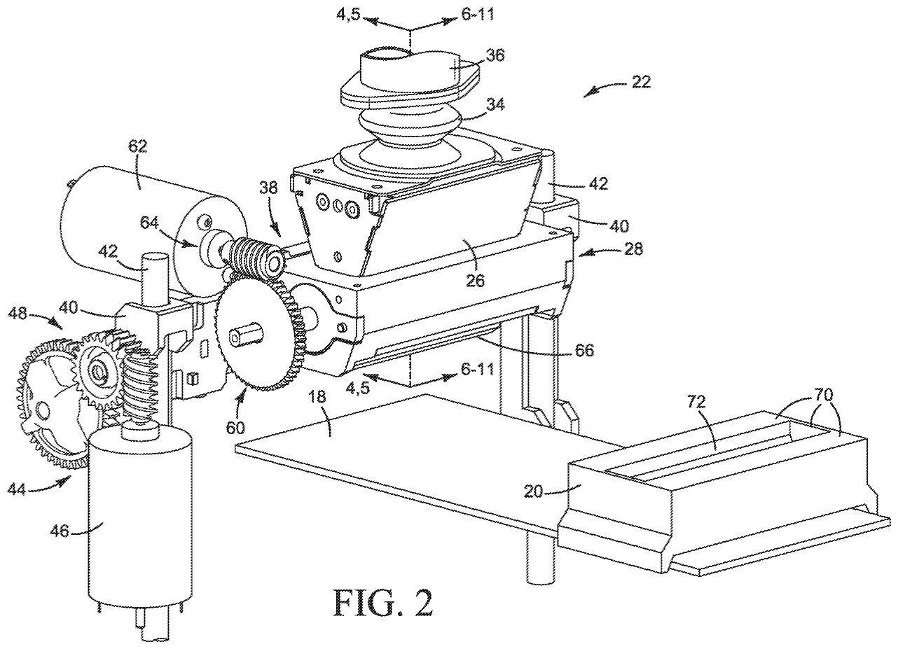

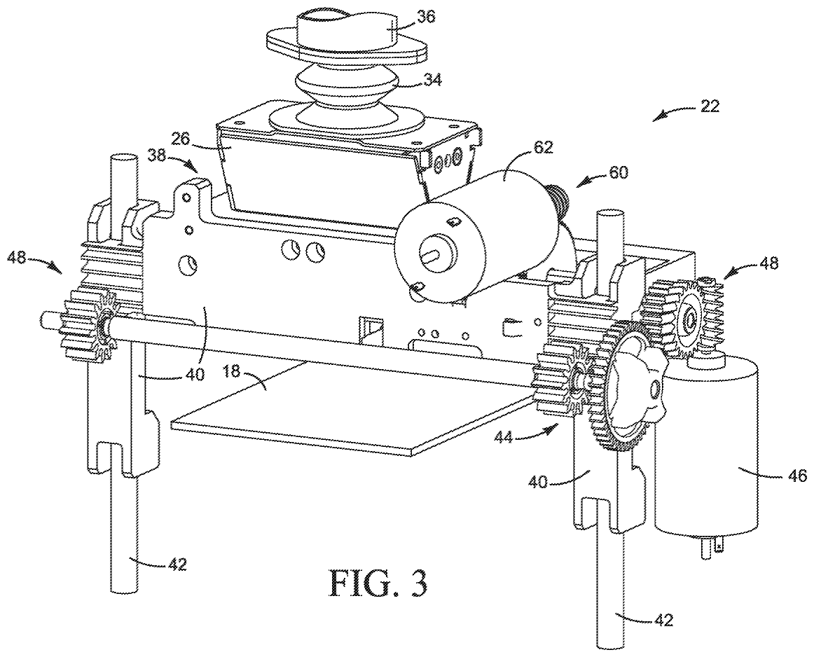

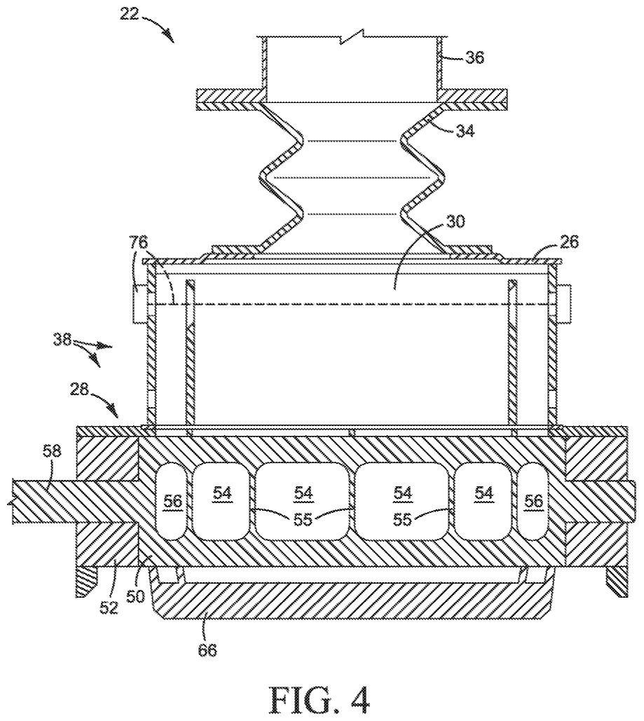

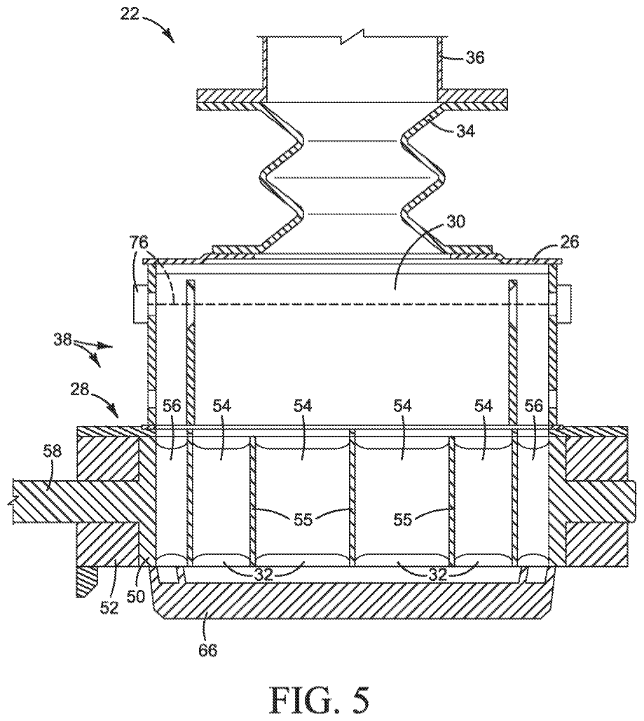

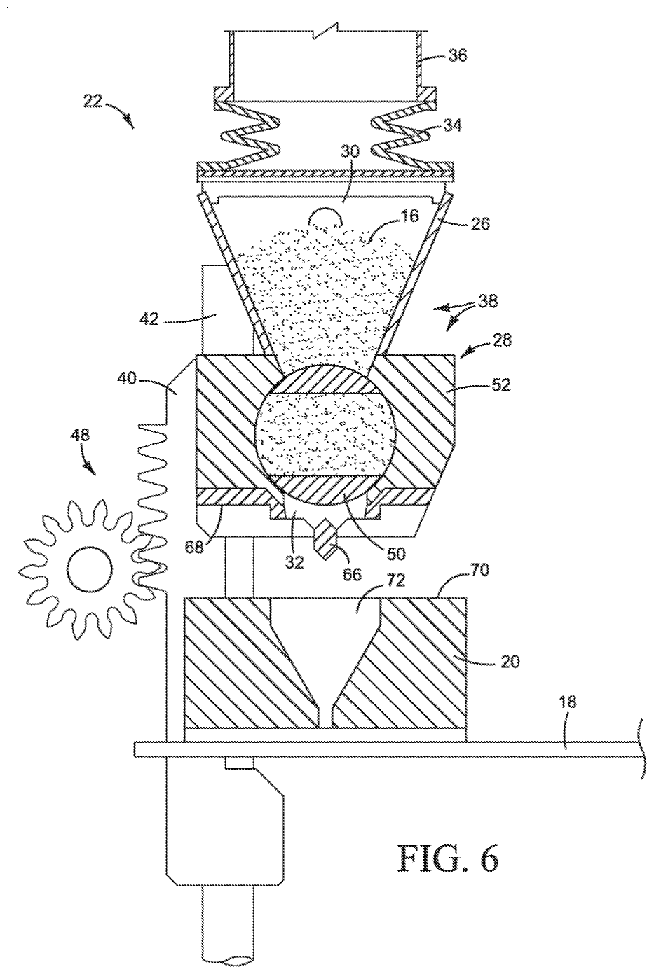

FIGS. 2 and 3 are perspective views illustrating one example of a refill control system 22 for a powder dispenser 20, such as might be used in the build material delivery system shown in FIG. 1. FIGS. 4 and 5 are lengthwise section views of the example powder refill control system shown in FIGS. 2 and 3. FIGS. 6-12 present a sequence of widthwise section views illustrating an example dispenser refill operation using control system 22 shown in FIGS. 2-5. Referring first to FIGS. 2-5, control system 22 includes a container 26 to hold powdered build material for refilling dispenser 20 and a valve 28 to control the flow of powder from container 26 to dispenser 20. System 22 also includes an inlet 30 through which powder flows into container 26 and an outlet 32 through which powder flows out of container 26.

As described in more detail below with reference to the sequence of FIGS. 6-11, valve 28 is operable between a closed position in which the flow of powder out through outlet 32 is blocked, as shown in FIG. 4, and an open position in which the flow of powder out through outlet 32 is not blocked, as shown in FIG. 5. In this example, refill control system 22 also includes a conduit 34 connecting container inlet 30 to a discharge port 36 from a pneumatic transport system 12 shown in FIG. 1, or from another source of powdered build material. Conduit 34 is a flexible, bellows like tube that expands and contracts in the direction of movement of container 26 to maintain a closed powder path between port 36 and container 26 during a refill operation.

In the example shown in FIGS. 2 and 3, container 26 and valve 28 are carried together as an assembly 38 on a carriage 40 that moves along guide rails 42. Carriage 40 is driven up and down along guide rails 42 by a linear actuator 44. Linear actuator 44 may be implemented, for example, with a motor 46 connected to carriage 40 through a gear train 48.

Referring now also to FIGS. 6-12, in this example valve 28 is implemented as a “cylinder” valve 28 that includes a cylindrical valve member 50 seated in a valve body 52 along the bottom of refill container 26. In this example, valve member 50 includes multiple powder ports 54 and multiple air ports 56 positioned outboard of the powder ports. Dividers 55 defining powder ports 54 add structural stability to valve member 50. In other examples, it may be possible (and desirable) to achieve adequate strength with fewer dividers 55 and thus fewer powder ports 54. Valve 28 also includes a valve stem 58 operatively connected to a rotary actuator 60 to open and close the valve. Rotary actuator 60 may be implemented, for example, with a motor 62 connected to valve stem 58 through a gear train 64.

As best seen in the section views of FIGS. 4-12, refill control system 22 includes an occupier 66 suspended below outlet 32 as part of container/valve assembly 38, to protrude into dispenser 20 during refilling.

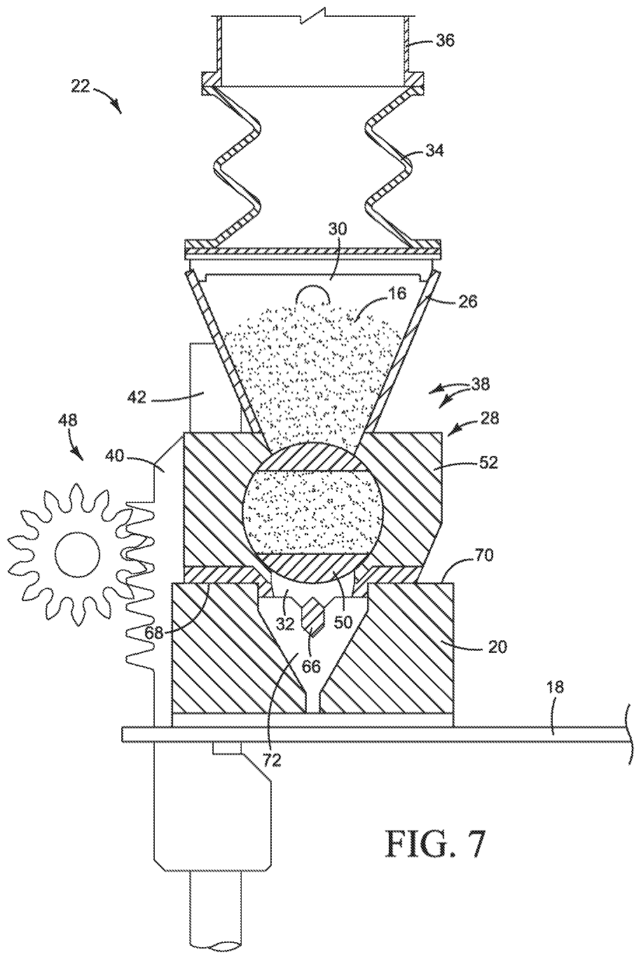

A refill operation will now be described with reference to the sequence of FIGS. 6-12. In FIG. 6, container 26 contains powdered build material 16, valve 28 is closed, and dispenser 20 has been moved into a refill position on platform 18 below the raised container/valve assembly 38. Conduit 34 is contracted. In FIG. 7, assembly 38 is lowered to dispenser 20. Conduit 34 is extended. A contact surface 68 along the bottom of assembly 38 surrounding outlet 32 contacts a mating surface 70 on dispenser 20 to enclose the powder flow path during refilling. A gasket (not shown) may be used to seal the joint between assembly 38 and dispenser 20 at contact surfaces 68, 70. Occupier 66 protrudes into dispenser 20 and thus occupies space within an interior volume that forms the dispenser's powder reservoir 72.

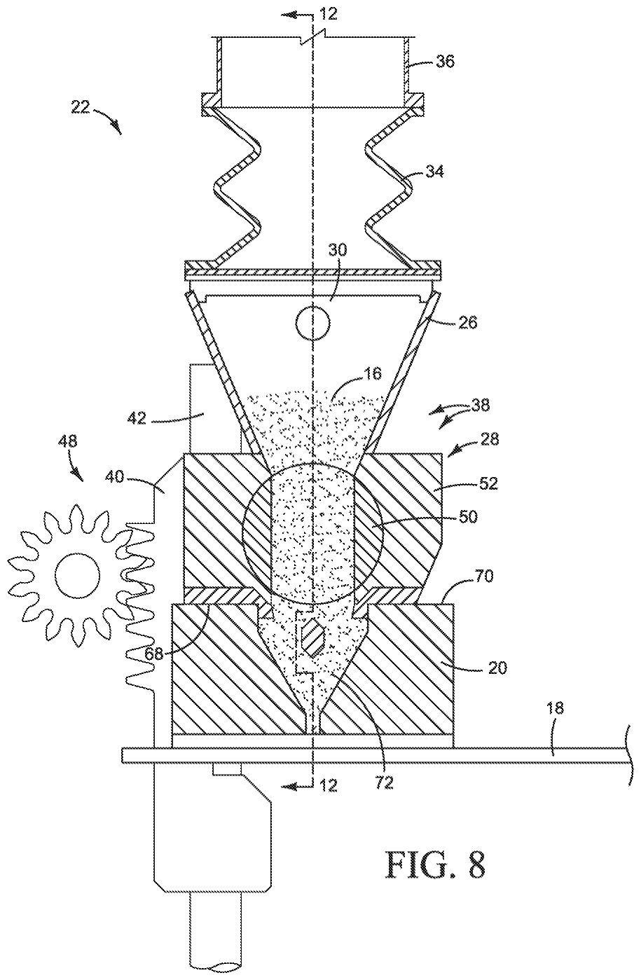

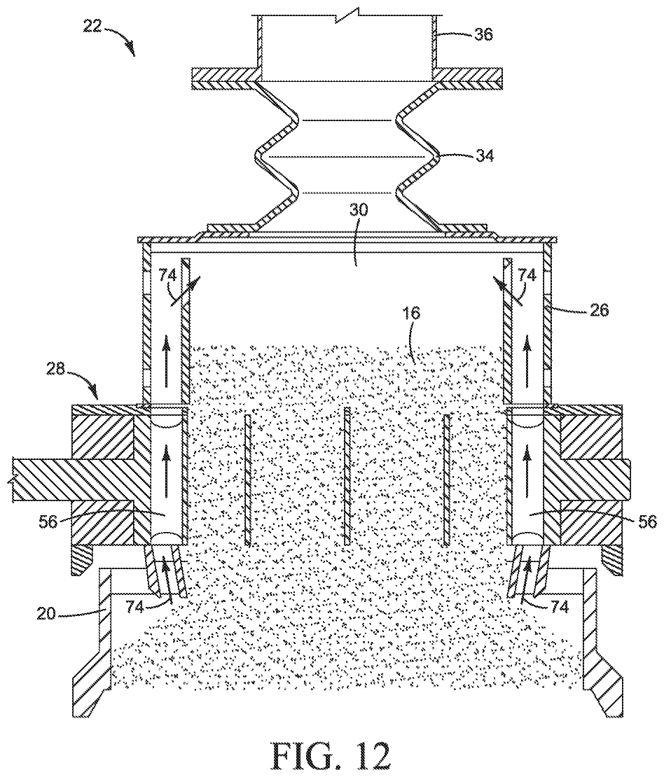

In FIGS. 8 and 12, valve is opened and powder 16 flows from container 26 into dispenser reservoir 72, depleting the supply of powder 16 in container 26. Air is vented from dispenser reservoir 72 through air ports 56 and container 20, as indicated by arrows 74 in FIG. 12, to help prevent air pressure from prematurely blocking the flow of powder into dispenser 20. Powder 16 will flow from container 26 into a vented dispenser reservoir 72 until the frictional flow properties of the powder choke off the flow. This passive, automatic flow shut-off helps maintain a uniform refill level for each powder or mix of powders regardless of how much powder is in dispenser 20 when it moves into the refill position.

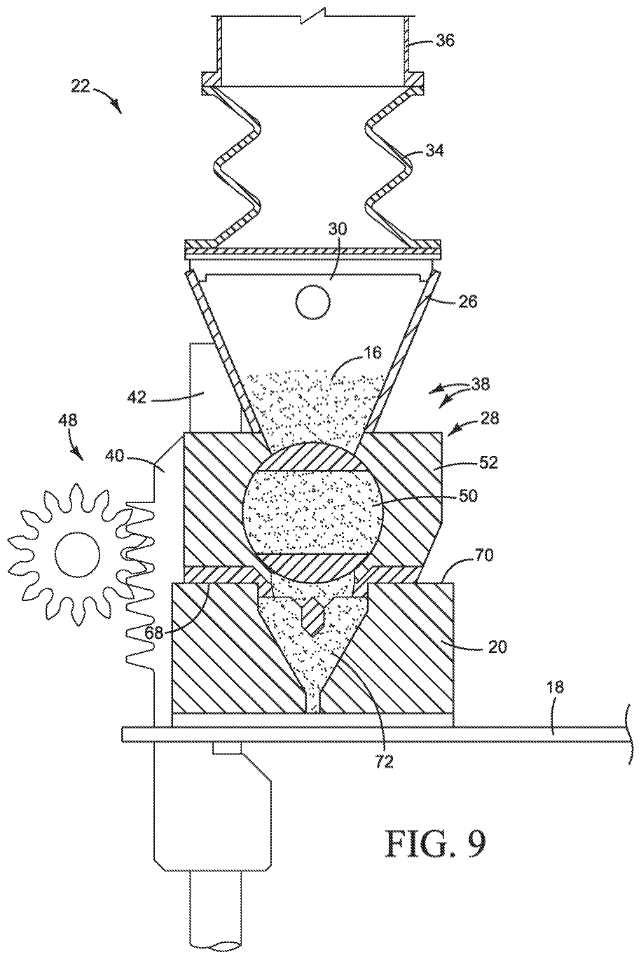

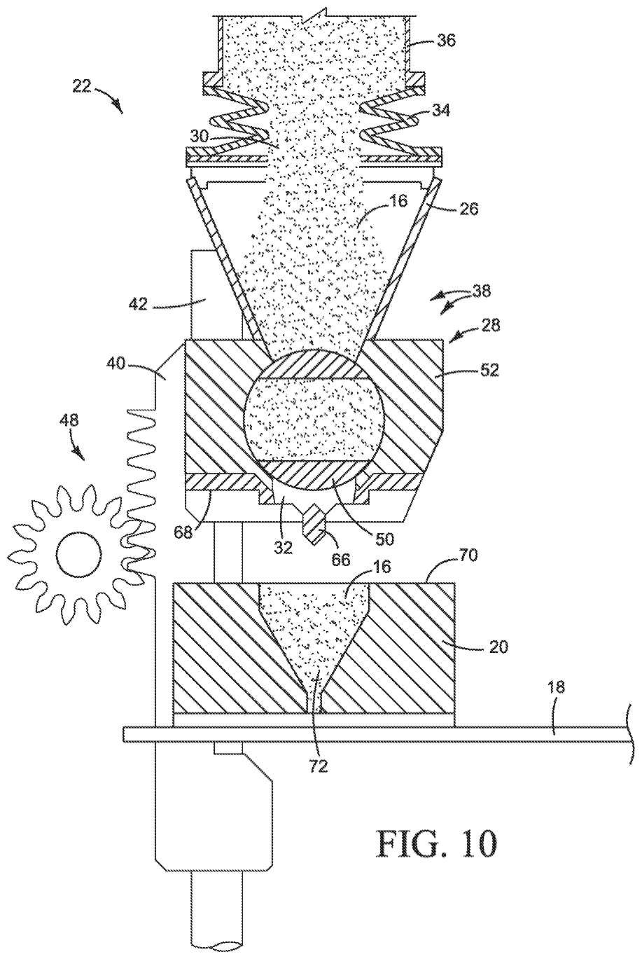

Then, in FIG. 9, valve 28 is closed and, in FIG. 10, assembly 38 is raised to disengage dispenser 20 and withdraw occupier 66 from reservoir 72. As occupier 66 is withdrawn from dispenser reservoir 72, build material powder 16 fills the void left by the withdrawn occupier to achieve the desired fill level in dispenser 20. The size of the occupier may be selected to achieve the desired fill level in dispenser 20. For example, a larger occupier may be used for a lower fill level and a smaller occupier used for a higher fill level. Occupier 66 may also be used to make space in dispenser reservoir for any powder that remains between valve member 50 and dispenser 20 when valve 28 is closed, to help reduce waste and to help reduce the risk of introducing airborne powder into the work area.

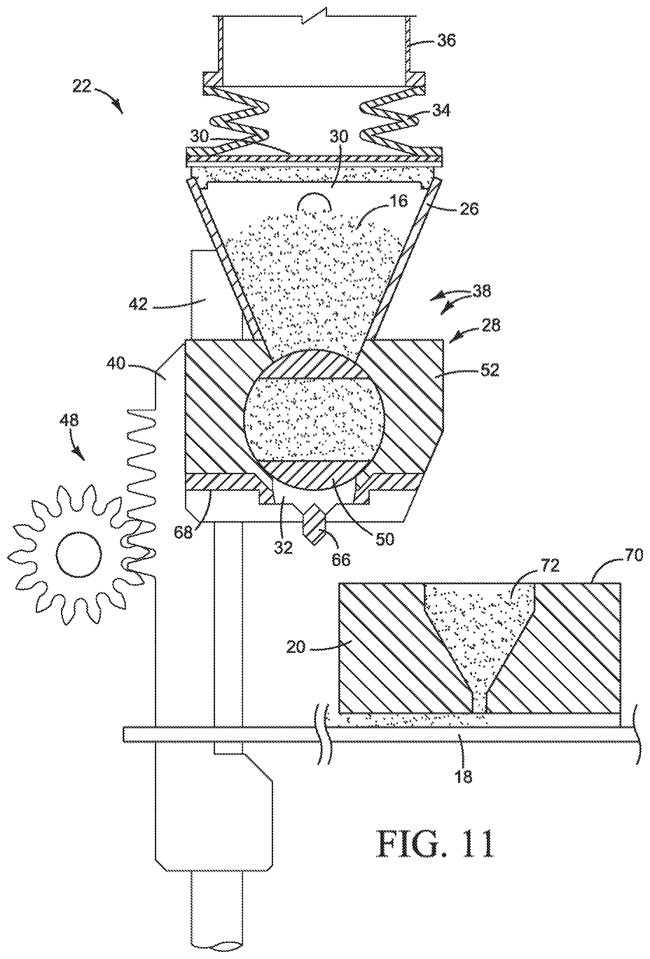

Also in FIGS. 10 and 11, container 26 receives powder 16 through discharge port 36 in preparation for the next dispenser refill operation, as dispenser 20 moves over platform 18 dispensing powder for the next layer of build material. As noted earlier, discharge port 36 represents any suitable source of powdered build material. For one example, as shown in FIG. 1, discharge port 36 may be the end of a pneumatic powder transport system 12. For another example, discharge port 36 may be the outlet from a supply hopper, which itself may be the end of a pneumatic powder transport system. The flow of powder into container 26 through discharge port 36 may start, for example, on a signal that valve 28 is closed and stop, for example, on a signal from a level sensor 76, shown in FIGS. 4 and 5.

A refill control system 22 intermediate to a pneumatic powder transport system 12 and a dispenser 20 allows recharging the local supply of powder while the dispenser is out dispensing powder for manufacturing the next layer of the object, thus giving transport system 12 more time to turn on, transport, and turn off compared to refilling dispenser 20 directly. Also, a refill control system 22 with a passive shut-off that automatically controls the refill level in dispenser 20, moves the location for active powder level sensing from dispenser 20 to container 26, where lower resolution sensing may be used to achieve the desired functionality.

The examples shown in the figures and described above illustrate but do not limit the patent, which is defined in the following Claims.

“A”, “an” and “the” used in the claims means one or more. For example, “a container” means one or more containers and subsequent reference to “the container” means the one or more containers.

1. A refill control system to periodically refill a dispenser with powdered build material, the system comprising:
a container to hold powered build material, the container movable from a first position to a second position to connect the container to the dispenser and from the second position to the first position to disconnect the container from the dispenser; and
a valve operable between a closed position to block a flow of powdered build material from the container to the dispenser and an open position to not block the flow of powdered build material from the container to the dispenser.

2. The system of claim 1, comprising an occupier to occupy space in an interior volume of the dispenser when the container is in the second position.

3. The system of claim 1, comprising:
an outlet through which powdered build material may flow from the container to the dispenser when the valve is open; and
a contact surface surrounding the outlet to contact a mating contact surface on the dispenser to enclose a powder flow path from the container to the dispenser.

4. The system of claim 3, comprising a vent through which air may escape an interior volume of the dispenser when the container is in the second position connected to the dispenser.

5. The system of claim 1, comprising:
an inlet through which powdered build material may flow into the container; and
a conduit connected to the inlet, the conduit expandable and contractable in a direction of movement of the container to lengthen when the container is moved from the first position to the second position and to shorten when the container is moved from the second position to the first position.

6. The system of claim 1, comprising:
a carriage carrying the container and the valve; and
a linear actuator to move the carriage up and down to carry the container back and forth between the first and second positions.

7. The system of claim 6, comprising a rotary actuator to open and close the valve.

8. A refill control system to control the flow of powdered build material to a dispenser to periodically refill the dispenser with powdered build material, the system comprising:
an assembly including:
a container to hold powdered build material;
a valve to control a flow of powdered build material from the container through an outlet;
a contact surface surrounding the outlet to contact a mating contact surface on the dispenser to enclose a powder flow path to the dispenser when the assembly is in contact with the dispenser; and
an occupier below the outlet to occupy space in an interior volume of the dispenser when the assembly is in contact with the dispenser;
a carriage carrying the assembly;
a linear actuator to move the carriage down and up into and out of contact with the dispenser; and
a rotary actuator to open and close the valve.

9. The system of claim 8, where the assembly includes a vent through which air may escape the interior volume of the dispenser when the assembly is in contact with the dispenser.

10. The system of claim 9, where the valve includes:
a cylindrical valve member having a first port to pass powder during a refill operation and a second port outboard from the first port to pass air during the refill operation;
a valve body supporting the valve member; and
a valve stem connected between the valve member and the rotary actuator.

11. The system of claim 10, where the valve member includes multiple first ports and multiple second ports, each second port outboard from all of the first ports.

12. The system of claim 11, where the assembly includes:
an inlet through which powdered build material may flow into the container; and
a conduit connected to the inlet, the conduit expandable and contractable in a direction of movement of the container to lengthen when the container is moved down and to shorten when the container is moved up.

13. A powdered build material delivery system for additive manufacturing, comprising:
a refillable dispenser to dispense powdered build material on to a supply deck or build platform;
a pneumatic powder transport system to transport powdered build material from a supply of powdered build material; and
a refill control system to control the flow of powdered build material from the transport system to the dispenser to periodically refill the dispenser with powdered build material.

14. The system of claim 13, comprising multiple powdered build material supplies connected to the transport system.

15. The system of claim 13, comprising a controller having processing and associated memory resources, and electronic circuitry and components to control operative elements of the dispenser, the transport system and the refill control system.
